(19) United States
(12) Patent Application Publication
(10) Pub. No.: US 2024/0332833 A1
(43) Pub. Date: Oct. 3, 2024

(54) CONDUCTOR CONNECTION TERMINAL WITH A PLURALITY OF SPRING-LOADED CLAMPING CONNECTIONS

(71) Applicant: WAGO Verwaltungsgesellschaft mbH, Minden (DE)

(72) Inventors: Sergej ZIER, Loehne (DE); Rudolf MASTEL, Minden (DE)

(73) Assignee: WAGO Verwaltungsgesellschaft mbH, Minden (DE)

(21) Appl. No.: 18/617,641

(22) Filed: Mar. 26, 2024

(30) Foreign Application Priority Data
Mar. 27, 2023 (DE) 20 2023 101 520.4

(51) Int. Cl. H01R 9/24; H01R 4/48

(52) U.S. Cl. CPC H01R 9/2416; H01R 4/4821; H01R 4/483; H01R 4/4848

(57) ABSTRACT

A conductor connection terminal with a plurality of spring-loaded clamping connections arranged directly next to one another in a row direction in a housing, each with a pivotable actuating lever, wherein an actuating lever is set up in each case to open the clamping point of an associated spring-loaded clamping connection, wherein the respective actuating lever has at least one grip area for manually gripping the actuating lever, which has a first longitudinal side and a second longitudinal side facing away therefrom.

This nonprovisional application claims priority under 35 U.S.C. § 119 (a) to German Patent Application No. 20 2023 101 520.4, which was filed in Germany on Mar. 27, 2023, and which is herein incorporated by reference.

### BACKGROUND OF THE INVENTION

### Field of the Invention

The invention relates to a conductor connection terminal with a plurality of spring-loaded clamping connections arranged directly next to one another in a row direction in a housing, each with a pivotable actuating lever, wherein an actuating lever is set up in each case to open the clamping point of an associated spring-loaded clamping connection, wherein the respective actuating lever has at least one grip area for manually gripping the actuating lever, which has a first longitudinal side and a second longitudinal side facing away therefrom.

### Description of the Background Art

A conductor connection terminal is known from EP 2 956 993 B1, which corresponds to US 2015/0372402, which is incorporated herein by reference.

### SUMMARY OF THE INVENTION

It is therefore an object of the invention of further miniaturizing a conductor connection terminal.

This object is achieved with a conductor connection terminal of the aforementioned type in that on the first longitudinal side there is a lateral gripping surface, which is suitable for manually gripping and/or actuating the actuating lever with the hand or at least with a finger or with a tool, and on the second longitudinal side a clearance space is formed via which a free space is provided for manually gripping and/or actuating the adjacent actuating lever with the hand or at least with a finger or with a tool on the lateral gripping surface arranged on the first longitudinal side of the adjacent actuating lever. Thus, in the case of actuating levers being arranged next to each other, the lateral gripping surface of one actuating lever can be arranged directly adjacent to free up space to the other, neighboring actuating lever. Sufficient space is provided by the clearance space to enable the actuating lever to be actuated on the lateral gripping surface even with very small and therefore highly miniaturized conductor connection terminals. In particular, it is possible to manually actuate the actuating lever on the lateral gripping surface directly with the hand or at least with one finger. The actuation can be done, e.g., with a fingernail. It is also possible to manually actuate the actuating lever on the lateral gripping surface with a tool, e.g., the blade of a screwdriver. In particular, the invention enables a simple and tool-free actuation of each individual actuating lever separately from one another, even with very small conductor connection terminals or plug connectors formed therewith. Accordingly, the user at his choice can open or close each individual clamping point with the associated actuating lever. The lateral gripping surface advantageously makes possible that the actuating lever can be at least lifted by manual actuation; i.e., the actuating lever is displaced from a closed position to a partially open position which is pivoted relative to the adjacent actuating lever and in which the actuating lever can be fully gripped with the fingers.

The first and second longitudinal sides of the actuating levers or the grip areas are those sides that face each other in the case of adjacent actuating levers; i.e., the second longitudinal side of the first actuating lever in the actuating lever row formed in the row direction faces the first longitudinal side of the adjacent actuating lever, etc.

The lateral gripping surface can run, e.g., at right angles to the plane in which the actuating lever can be pivoted or at an oblique angle thereto, e.g., at an angle between 10° and 80°. In particular, the lateral gripping surface is arranged or designed such that a sufficient actuating force can be exerted on it to pivot the actuating lever from an unactuated position into an actuated position in which the clamping point is opened by the actuating lever.

An indentation can be formed in the first longitudinal side of the grip area, wherein the lateral gripping surface is formed at the indentation. In this way, basically, part of the space surrounded by the grip area can be used for the arrangement of the lateral gripping surface and accordingly for the actuation of the actuating lever. The indentation can be formed, e.g., as an undercut, recess, or the like. The lateral gripping surface can be arranged on an inner wall of the indentation or form such an inner wall.

The clearance space can be designed as a cut-out on the second longitudinal side, e.g., a cut-out without an undercut. In particular, the clearance space can have a special shape to enable free access to the indentation of a first longitudinal side of the grip area of the adjacent actuating lever in an ergonomic manner.

One, multiple, or all actuating levers can each have an axis of rotation about which they are pivotably mounted. In this regard, the actuating lever can be designed with a fixed axis of rotation in the housing of the conductor connection terminal or with an axis of rotation that can be moved to a certain extent, e.g., if the actuating lever is mounted in a floating manner. The actuating lever can be pivotably mounted in the housing of the conductor connection terminal or, alternatively or additionally, also on a contact assembly of the respective spring-loaded clamping connection.

The grip areas of adjacent actuating levers can be arranged at a common height level. In the unactuated state, the grip areas of the actuating levers are thus arranged next to each other in alignment in the height direction. In this way, the conductor connection terminal can be designed to be particularly compact and accordingly highly miniaturized. Advantageously, the grip area of multiple or all actuating levers can be arranged on the same housing side of the conductor connection terminal, e.g., on the housing side on which the electrical conductors that are to be clamped to the spring-loaded clamping connections are also inserted into the housing, i.e., on a conductor insertion side of the housing.

Multiple or all actuating levers can each have the lateral gripping surface on the first longitudinal side and the clearance space on the second longitudinal side. Accordingly, multiple or all actuating levers can be easily actuated individually with the finger or a tool on the lateral gripping surface, even in a highly miniaturized example.

Multiple or all actuating levers can be formed identical or at least identical in the grip area. In this way, the conductor connection terminal can be provided cost-effectively, as the actuating levers can be designed as identical parts. In addition, an attractive appearance of the conductor connection terminal can be realized.

Multiple or all actuating levers can be designed with the same lever arm length. This has the advantage that the actuating forces on the actuating levers are the same, at least if similar spring-loaded clamping connections are used, so that the actuation is always the same for the user, regardless of which actuating lever is to be actuated. In addition, if the axes of rotation of the actuating levers are arranged aligned with each other, the conductor connection terminal can be realized as a conductor connection terminal in which the actuating levers end at a common line or plane, e.g., on the conductor connection side of the housing.

Multiple or all actuating levers can be designed with a fixed lever arm length. Accordingly, the lever arm length of the actuating levers is not variable, which has the advantage that the mechanical construction of the conductor connection terminal can be made simple and robust. In addition, the user is not confronted with varying actuating forces of the actuating levers.

Multiple or all actuating levers can be set up for a manual application of force, eccentrically in the transverse direction, during manual gripping and actuation of the actuating lever at its grip area. In this regard, the transverse direction can correspond, e.g., to the row direction of the spring-loaded clamping connections. Due to their lateral gripping surface, the actuating levers are therefore not to be actuated centrally, or at least not in the intended manner, but rather laterally on the lateral gripping surface, which is arranged off-center.

Multiple or all actuating levers can have a tangential lateral actuating surface, arranged on their first and/or second longitudinal side, for actuating a clamping leg of the clamping spring of an associated spring-loaded clamping connection. This allows an advantageous transmission of force to spring-loaded clamping connections, which are also made miniaturized, e.g., spring-loaded clamping connections with a single, angled leaf spring. This has the advantage that the actuating lever can also be easily miniaturized and thus enables the realization of a miniaturized conductor connection terminal with a large number of contact assemblies. In addition, the manual actuation force required for the actuating lever can be minimized by such tangential actuation of the clamping spring.

The spring tongue or its clamping edge of the clamping spring of the associated contact assembly can be moved away from the busbar component by manual actuation of the respective pivotable actuating lever. The clamping point can thus be opened by such a manual actuation. In the open state of the clamping point, an electrical conductor can be placed at the clamping point or removed from the conductor connection terminal without significant force.

The conductor connection terminal can be designed as an electrical plug connector, wherein the spring-loaded clamping connections each have at least one plug-in contact. In this way, an advantageous electrical plug connector can be provided in a miniaturized design with simple connection options for the electrical conductors, namely, via lever-actuated spring-loaded clamping connections.

The spring-loaded clamping connections can each have at least one contact assembly for connecting an electrical conductor via spring-loaded clamping, with the following features: the contact assembly has a busbar component, the contact assembly has a spring component with a clamping spring, wherein the spring component is mechanically connected to the busbar component and is designed to clamp an electrical conductor to the busbar component at the clamping point via the clamping spring.

In this way, an advantageous miniaturized contact assembly can be provided for forming a spring-loaded clamping connection. The contact assembly overall can be made up of just these two components, i.e., the busbar component and the spring component.

The spring component can have as a clamping spring a single-sided leaf spring, which is designed as a spring tongue, which is angled with respect to the conductor insertion direction, arranged at an angle in the direction of the busbar component, and has a clamping edge at the free end, wherein the clamping point for clamping the electrical conductor is formed between the busbar component and the clamping edge. This allows reliable and simple clamping of an electrical conductor with a comparatively simple design of the contact assembly. In particular, it is not necessary for symmetrical clamping to occur using two spring tongues running in opposite directions. Due to the single-sided clamping by the angled spring tongue, the electrical conductor can be reliably clamped and electrically contacted at the clamping point on the busbar component.

The spring tongue can be designed as a material tongue made from the material of the spring component and bent. This minimizes the number of components in the contact assembly and simplifies production and assembly.

The spring tongue can have a projecting actuating tab for actuating the spring tongue. This allows simple and reliable mechanical actuation and, accordingly, deflection of the spring tongue via an actuating element, for example, an actuating lever, which will be explained hereinbelow. The actuating tab can be formed, for example, in one piece with the spring tongue.

Further scope of applicability of the present invention will become apparent from the detailed description given hereinafter. However, it should be understood that the detailed description and specific examples, while indicating preferred embodiments of the invention, are given by way of illustration only, since various changes, combinations and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1 and 2 show an actuating lever in different perspective views;

FIG. 3 shows a conductor connection terminal in perspective view;

FIGS. 4 and 5 show examples of an actuating lever in different perspective views;

FIG. 6 shows an example of a conductor connection terminal in a perspective view;

FIGS. 7 and 8 show an example of an actuating lever in different perspective views;

FIG. 9 shows an example of a conductor connection terminal in a perspective view;

FIG. 10 shows a contact assembly with an actuating lever in the unactuated state; and

FIG. 11 shows the contact assembly with the actuating lever in the actuated state.

### DETAILED DESCRIPTION

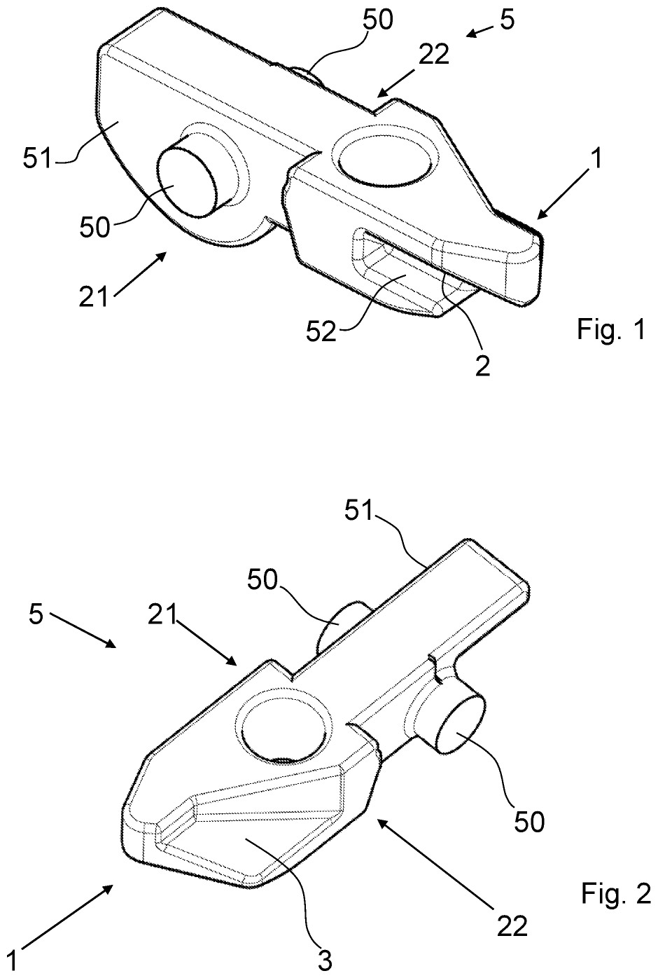

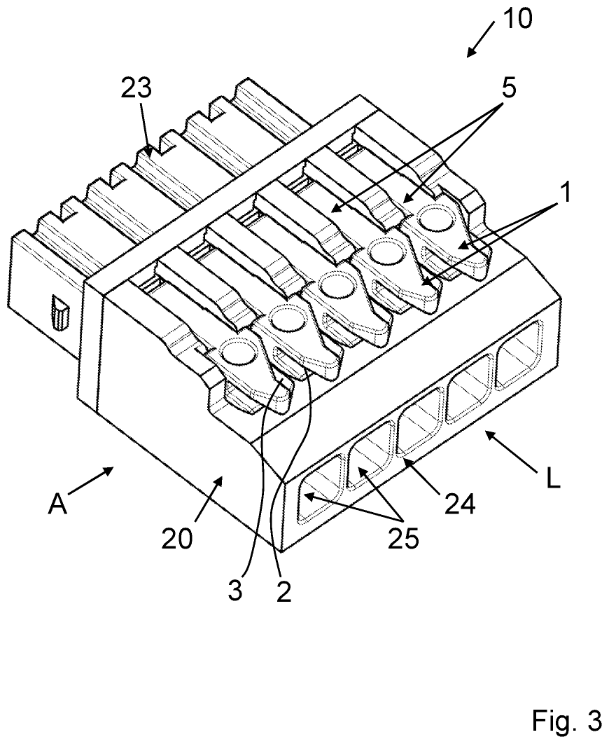

FIGS. 1 and 2 show an actuating lever 5, which is designed to open the clamping point of a spring-loaded clamping connection. FIG. 1 here shows an oblique view of a first longitudinal side 21 of actuating lever 5, and FIG. 2 shows an oblique view of second longitudinal side 22 facing away from first longitudinal side 21.

Actuating lever 5 has a spring actuating section 51, which can be used to act on the clamping spring of a spring-loaded clamping connection in order to open the clamping point. Actuating lever 5 can be pivoted about a pivot axis. There are various options for realizing the pivot axis. For example, as shown in FIGS. 1 and 2, the actuating lever can have laterally molded pivot pins that form an axis of rotation 50, with which it can be rotatably mounted in the housing of the conductor connection terminal or on a contact assembly. It is also possible for actuating lever 5 to have receptacles for receiving an axis of rotation; i.e., it is then designed without the pivot pins. Seen from the spring actuating section 51, behind axis of rotation 50, actuating lever 5 has a grip area 1 for manually gripping actuating lever 5 in order to carry out the pivoting movement.

As can be seen, actuating lever 5 has in grip area 1 on first longitudinal side 21 a lateral gripping surface 2, which is suitable for manually gripping and/or actuating the actuating lever 5 with the hand or at least with a finger or a tool. In this case, lateral gripping surface 2 is formed as an inner wall of an indentation 52, which extends into the interior of the space surrounded by grip area 1. To actuate a spring-loaded clamping connection when opening the clamping point, a fingernail or a tool, e.g., can be used to engage indentation 52 and force can be applied to lateral gripping surface 2 from below, as seen in the drawing view, in order to thereby pivot actuating lever 5 about axis of rotation 50.

FIG. 2 illustrates that actuating lever 5 has a clearance space 3 in grip area 1 on second longitudinal side 22. In other words, grip area 1 is provided with a certain cut-out on second longitudinal side 22 in order to create a free space for gripping an adjacent actuating lever 5 on its lateral gripping surface 2.

FIG. 3 illustrates the arrangement of multiple actuating levers 5 of the type described above in a conductor connection terminal 10. Conductor connection terminal 10 has multiple spring-loaded clamping connections arranged next to each other in a row direction A in a housing 20. Spring-loaded clamping connections can be arranged, e.g., directly next to each other or separated from each other only by a housing wall. An actuating lever 5 is assigned to each spring-loaded clamping connection for actuation. It can be seen that actuating levers 5 or at least their grip areas 1 are arranged directly next to each other and there is no or only a very small distance between grip areas 1. In order to still be able to easily actuate an actuating lever 5 with the finger or a tool in a miniaturized version of such a conductor connection terminal 10, clearance space 3 of an actuating lever 5 enables a good accessibility of lateral gripping surface 2 of the adjacent actuating lever 5, because clearance space 3 provides a corresponding additional free space.

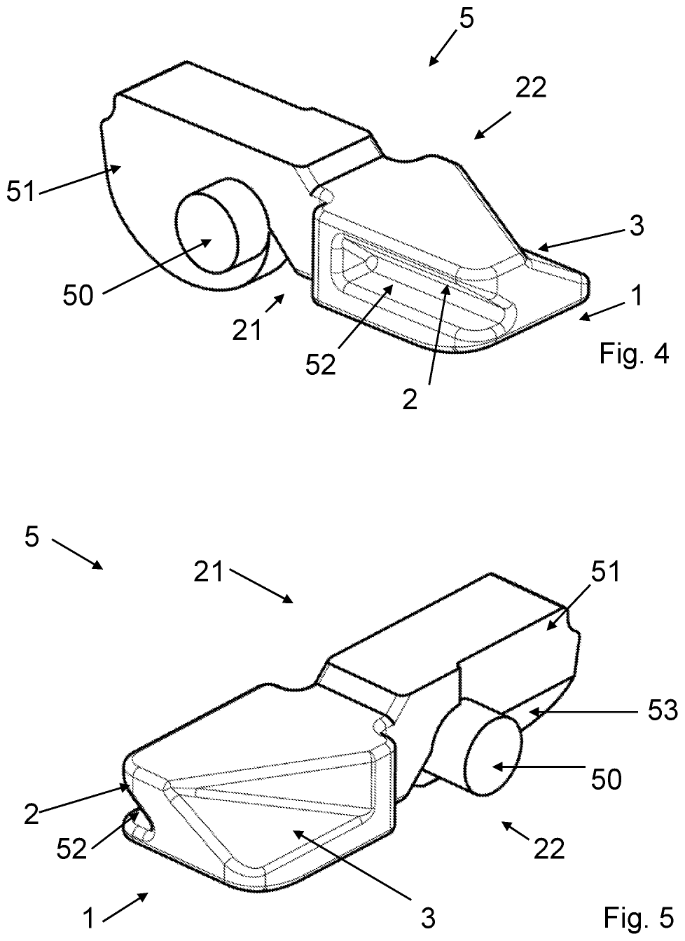

FIGS. 4 and 5 show an example of an actuating lever 5, in views comparable to those in FIGS. 1 and 2. Actuating lever 5 according to FIGS. 4 and 5 is designed in a similar way to the actuating lever in FIGS. 1 and 2, wherein, in the example of FIGS. 4 and 5, indentation 52 extends to the free end of actuating lever 5 in grip area 1. Clearance space 3 arranged on the other side is shaped slightly differently than in FIGS. 1 and 2 in order to provide a free space adapted to the different shape of indentation 52.

It can also be seen in FIG. 5 that actuating lever 5 can have a tangential lateral actuating surface 53, arranged on its first and/or second longitudinal side 21, 22 on the spring actuating section 51, for actuating a clamping leg of the clamping spring of an associated spring-loaded clamping connection. Such a tangential lateral actuating surface 53 may also be present in the example of FIGS. 1 and 2.

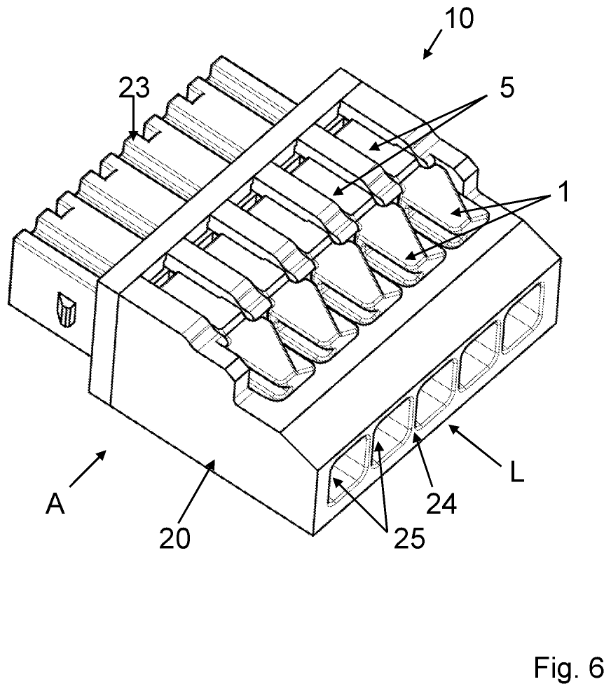

FIG. 6 illustrates the arrangement of actuating levers according to FIGS. 4 and 5 in a conductor connection terminal 10.

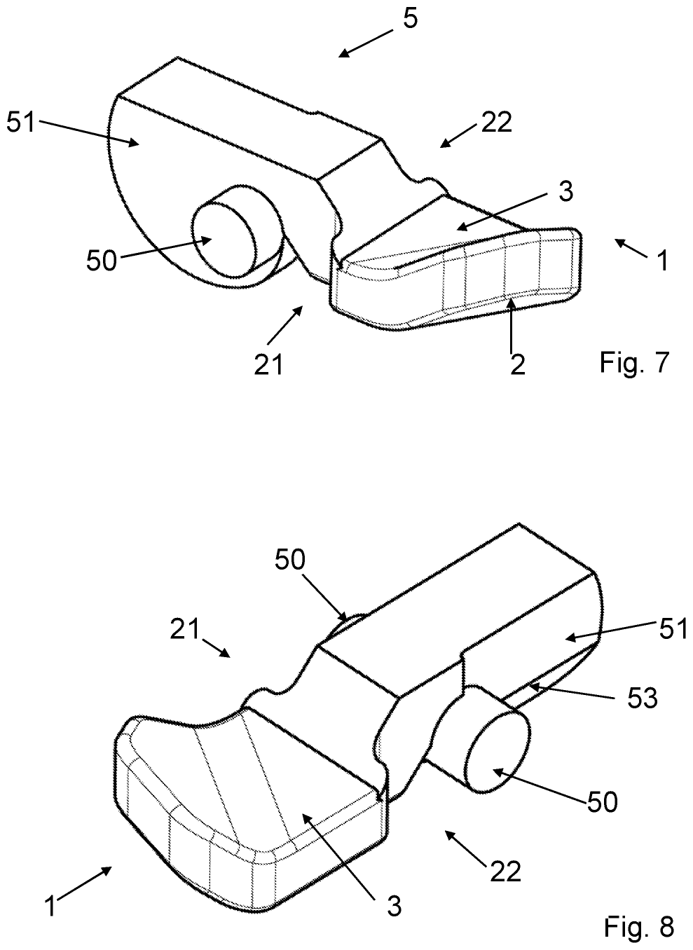

FIGS. 7 and 8 show an actuating lever 5 which is designed similar to the example in FIGS. 1 and 2, wherein grip area 1 is designed differently. In FIGS. 7 and 8, grip area 1 does not have indentation 52 on first longitudinal side 21. Instead, grip area 1 as a whole is formed with a curvature in a direction at an angle to the axis of rotation 50. In particular, at the free end of grip area 1 there is an upwardly curved end section—or, in relation to housing 20 an end section pointing away from housing 20—on which lateral gripping surface 2 is formed on the underside, i.e., the side pointing towards housing 20. Clearance space 3 is located on the opposite side. In the example shown, grip area 1 has a lower material thickness than the section of actuating lever 5 adjoining the grip area. However, this is not absolutely necessary.

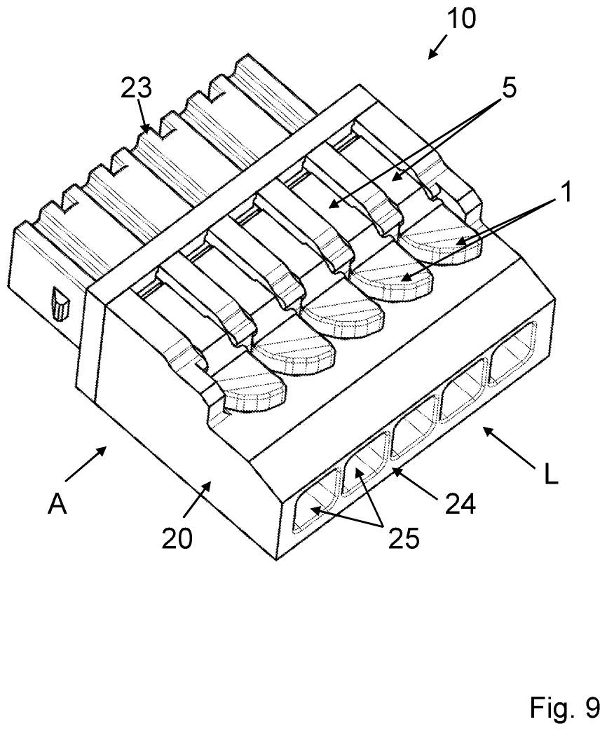

FIG. 9 shows a conductor connection terminal 10 with multiple actuating levers 5 arranged next to each other as in the example of FIGS. 7 and 8.

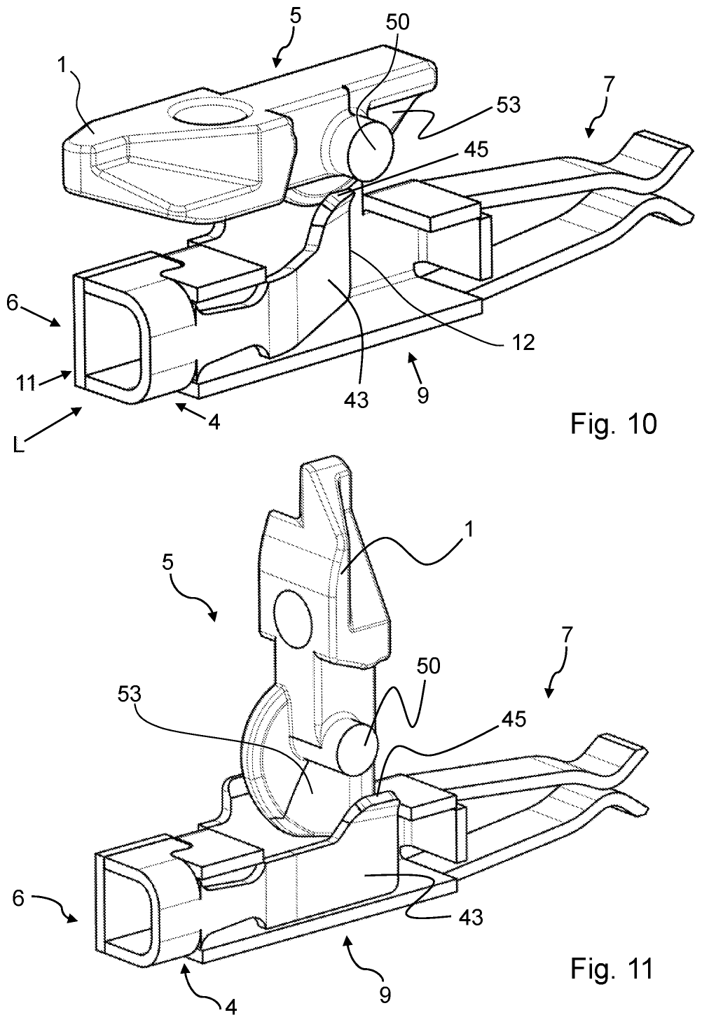

FIGS. 10 and 11 show a contact assembly 9 for connecting an electrical conductor via spring-loaded clamping. Contact assembly 9 has a busbar component 6, which is formed of a busbar material with good electrical conductivity, for example, copper or a copper alloy, and a spring component 4, which is formed of a spring material, for example, spring steel. Spring component 4 has a clamping spring in the form of a single-sided leaf spring, which is designed as a spring tongue 43 and is made from the material of spring component 4 and bent. An electrical conductor can be inserted into contact assembly 9 in a conductor insertion direction L through a conductor insertion opening 11 and guided to a clamping point 12, at which the electrical conductor can be pressed against the busbar component 3 via the spring force of spring tongue 43 and in this way can be mechanically fixed and at the same time electrically contacted. Spring tongue 43 is angled with respect to the conductor insertion direction L and points in the direction of busbar component 3. Spring tongue 43 can have a clamping edge at its free end.

In addition, an actuating tab 45, which projects from spring tongue 43 and can be used to actuate the spring tongue via an actuating lever 5, is present on spring tongue 43. Actuating tab 45 can be at a slight angle relative to spring tongue 43.

FIGS. 10 and 11 additionally show an example of contact assembly 9 in which an electrical plug-in contact 7 is formed on busbar component 6 behind clamping point 10 in the conductor insertion direction L, e.g., by one-piece molding from the material of busbar component 6. Plug-in contact 7 can be formed, e.g., as a bifurcated contact or other socket contact, as shown, but plug-in contact 7 can also be formed differently, e.g., as a blade or pin contact. As a result, the contact assembly can be used as part of an electrical plug connector.

FIG. 10 shows contact assembly 9 with a pivotable actuating lever 5 arranged thereon according to one of the examples described above. FIG. 10 shows the arrangement of contact assembly 9 and actuating lever 5 in the unactuated state of actuating lever 5. In the unactuated state of actuating lever 5, clamping point 12 is closed; i.e., spring tongue 43 is in contact with busbar component 6 when no electrical conductor is inserted there, or presses the electrical conductor against busbar component 6.

FIG. 11 shows the arrangement according to FIG. 10 with actuating lever 5 in an actuated position. Actuating lever 5 is now pivoted by a certain angle. Spring tongue 43 has now been deflected by actuating surface 53, which interacts with actuating tab 45, and has thus been moved away from its contact surface on busbar component 6. In this state, clamping point 12 is open.

The conductor connection terminals 10 shown in FIGS. 3, 6, and 9 each have conductor insertion openings 25 on a conductor insertion side 24 of housing 20. Electrical conductors can be inserted into the respective contact assemblies 9 through conductor insertion openings 25 of housing 20. On the side diametrically opposite conductor insertion side 24, housing 2 has a plug-in area 23, with which conductor connection terminal 10 or the electrical plug connector formed with it can be plugged together with a mating connector. The respective plug contacts 7 of contact assemblies 9 are arranged within plug-in area 23.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor connection terminal comprising:
a housing; and
at least two spring-loaded clamping connections arranged directly next to one another in a row direction in the housing, each of the at least two spring-loaded clamping connections having a pivotable actuating lever,
wherein an actuating lever is set up in each case to open a clamping point of an associated spring-loaded clamping connection,
wherein the respective actuating lever has at least one grip area for manually gripping the actuating lever, which has a first longitudinal side and a second longitudinal side facing away therefrom,
wherein, on the first longitudinal side, there is a lateral gripping surface, which is provided for manually gripping and/or actuating the actuating lever with a hand or at least with a finger or with a tool, and
wherein, on the second longitudinal side, a clearance space is formed via which a free space is provided for manually gripping and/or actuating the adjacent actuating lever with the hand or at least with the finger or with the tool on the lateral gripping surface arranged on the first longitudinal side of the adjacent actuating lever.

2. The conductor connection terminal according to claim 1, wherein an indentation is formed in the first longitudinal side of the grip area, and wherein the lateral gripping surface is formed at the indentation.

3. The conductor connection terminal according to claim 1, wherein one, multiple, or all actuating levers each have an axis of rotation about which they are pivotably mounted.

4. The conductor connection terminal according to claim 1, wherein the grip areas of adjacent actuating levers are arranged at a common height level.

5. The conductor connection terminal according to claim 1, wherein multiple or all actuating levers each have the lateral gripping surface on the first longitudinal side and the clearance space on the second longitudinal side.

6. The conductor connection terminal according to claim 1, wherein multiple or all actuating levers are formed identical or at least identical in the grip area.

7. The conductor connection terminal according to claim 1, wherein multiple or all actuating levers are designed with the same lever arm length.

8. The conductor connection terminal according to claim 1, wherein multiple or all actuating levers are designed with a fixed lever arm length.

9. The conductor connection terminal according to claim 1, wherein multiple or all actuating levers are set up for a manual application of force, eccentrically in the transverse direction, during manual gripping and actuation of the actuating lever at its grip area.

10. The conductor connection terminal according to claim 1, wherein multiple or all actuating levers have a tangential lateral actuating surface arranged on their first and/or second longitudinal side to actuate a clamping leg of the clamping spring of an associated spring-loaded clamping connection.

11. The conductor connection terminal according to claim 1, wherein the conductor connection terminal is an electrical plug connector, and wherein the spring-loaded clamping connections each have at least one plug-in contact.

12. The conductor connection terminal according to claim 1, wherein the spring-loaded clamping connections each have at least one contact assembly for connecting an electrical conductor via spring-loaded clamping, and the contact assembly further comprising:
a busbar component; and
a spring component with a clamping spring, the spring component being mechanically connected to the busbar component and is designed to clamp an electrical conductor to the busbar component at the clamping point via the clamping spring.
